(19) United States
(12) Patent Application Publication
(10) Pub. No.: US 2005/0081354 A1
(43) Pub. Date: Apr. 21, 2005

(54) METHOD AND APPARATUS FOR RIVET REMOVAL AND IN-SITU REHABILITATION OF LARGE METAL STRUCTURES

(75) Inventors: Douglas W. Motzno, Raleigh, NC (US); Bruce J. Loughton, Earleville, MD (US)

Correspondence Address: SUMMA & ALLAN, P.A., 11610 NORTH COMMUNITY HOUSE ROAD, SUITE 200, CHARLOTTE, NC, 28277, US

(73) Assignee: HYDRILL, INC., Raleigh, NC (US)

(21) Appl. No.: 10/605,666

(22) Filed: Oct. 16, 2003

(51) Int. Cl. B23P 6/00; B23P 19/04

(52) U.S. Cl. 29/402.12; 29/402.08; 29/402.09; 29/402.11; 29/426.4; 29/426.5; 29/700

(57) ABSTRACT

A method and apparatus are disclosed for replacing riveted metal components in place on existing metal structures. The method includes the steps of positioning a rivet removing tool at a rivet on an in situ structural component that is maintained in place by a plurality of rivets, encoding the position of the rivet removing tool at the rivet and transmitting the encoded position of the rivet to a processor, removing the rivet, sequentially moving the rivet removing tool to each of the rivets on the structural component that hold the structural component in place, sequentially encoding the position of the rivet removing tool at each rivet, transmitting the encoded the position of each rivet to the processor, and removing each rivet with the tool when the tool is at the rivet, designing a replacement component based upon the encoded positions of the rivets and fabricating the replacement component based on the transmitted rivet positions.

### BACKGROUND OF INVENTION

The present intention relates to rehabilitation of metal structures and in particular relates to rivet replacement and component part replacement on metal bridges.

Steel or iron bridges came into wide existence during the 19^{th} century, and the use of rivets to fix structural components to one another covers a number of decades, extending from before 1900 to at least the late 1950's. Accordingly, based on normal use and fatigue on such structures, a large number will need to be either rehabilitated or replaced in the foreseeable future. Smaller structures are often easier and less expensive to replace instead of repair, but as the size of the structure increases, rehabilitation becomes a more attractive option, and in some circumstances an economic necessity.

Such steel or iron structures are formed by a large number of individual girders (using the term as broadly as possible) as well as various connecting components such as splice plates. Many (and in some cases all) of these components are fixed together in place by rivets. Most typically, a rivet spans two or more components that overlie one another in layers (“plies”) to form a load-bearing connection. Such connections can suffer from particular load stresses from weakening of the component parts from degradation of the riveted connections, or from several or all such factors. In order to rehabilitate such connections, and regardless of whether a full component must be replaced, the rivets must be removed from the plies and replaced with another fastener.

As examples of the potential scope of such repairs, estimated replacements potentially include 471,000 rivets on the Oakland Bay Bridge, 68,000 rivets on the Golden Gate Bridge and 156,000 rivets on the Manhattan Bridge.

Replacing rivets in such structures raises a number of issues. First, current rivet removal methods are generally unsatisfactory and the effort, time and cost of replacing rivets is highly unpredictable. Such unpredictability makes it difficult or impossible for engineers and contractors to comply with contractual or environmental specifications without seeking variance or exemption. Furthermore, rivets must be replaced in a manner that limits substrate damage.

The nature and manner in which rivets are typically used and placed in structures leads to certain of the removal problems. As generally well understood by those familiar with riveting techniques (even though these are used less frequently in current applications), a rivet with a preformed head at one end is heated to a temperature at which it is malleable, although not flowing as a liquid. The shaft or “shank” of the rivet is then inserted in pre-drilled holes in the various plies. The opposite end of the heated rivet is then typically hammered into place to form a second head that fixes the plies into the desired position or relationship. Hammering the rivet also helps the heated shank to expand to fill the rivet hole. The malleable characteristics of the heated rivet, however, also permit the rivet to be inserted into misaligned holes between the various plies. As the rivet cools it contracts and promotes a snug fit and the tightening of the connection into which it was inserted, including a tightening of misaligned holes between plies. As a result, many rivets are not aligned as simple cylinders in cylindrical openings, but instead are somewhat mis-shaped and are wedged between uneven plies (e.g. FIG. 3). In an original structure, of course, such misalignment can help maintain the components together. In a removal context, however, the misalignment greatly increases the difficulty of removing the rivet in conventional fashion.

Rivet removal is also subject to legal and regulatory oversight usually by federal or state authority or both. For example, the United States Army Corps of engineers does not permit flame to be used (welding torches) and instead requires impact hammers and screw drills only. All of the various specifications require reaming and grinding of the opening that remains after the rivet has been removed and in each case if the substrate is damaged, the cost is charged back to the contractor.

Furthermore, because most steel or iron structures are painted, and because the paint typically contains lead, the contractor is required to avoid the release of lead into the environment as the rivets are being removed and the bridge is being rehabilitated. Because controlling lead abatement is difficult in impact or flame removal techniques, the contractor is typically required to remove the lead-containing paint prior to any attempt to remove the rivet. Such removal typically requires an extra step of abrasive spot blasting carried out in a controlled fashion requiring total encapsulation or negative containment of paint debris and spent abrasive.

In conventional techniques, and following paint removal, the rivet head is typically beaten off with a pneumatic chisel or “washed” off with a torch. The shank of the rivet is then driven out with a pneumatic punch or drill. The resulting hole is then drilled and reamed to align the opening for the bolts which are typically used to replace rivets in modern rehabilitation techniques. Any burrs, divots, or sharp edges are typically removed from the opening with hand tools.

As another problem, all of the conventional removal procedures require skilled journeyman, tradespersons or the like, andbecause rivets are being used less frequently in large constructionsuch persons are becoming harder to find.

As another problem, the times required to complete the conventional removal steps are not consistently reproducible and thus production rates are difficult to estimate. As a result, bids typically show large differences between contractors and their ability to reasonably estimate the degree of difficulty (and thus the cost) of removing the rivets.

As an additional problem much of the work in rehabilitating bridge structures includes the repair or replacement of splice plates, fabricated shapes, and flanges. The majority of steel rehabilitation work thus occurs at critical connections and areas of section loss as a result of corrosion inherent with coating failure. In particular, spice plate overlay is a significant source of seismic retrofit activity. These components are predominantly relatively small and often include tightly configured rivet patterns. Thus, replacing these components typically requires that the component's shape, size and rivet location be carefully measured, the measurements sent to a fabrication shop, the replacement component manufactured at the shop and returned to the bridge, and then piece-matched in place on the bridge with any remaining adjustments being made in place by hand. As a result, tool positioning and fabrication are time consuming and difficult, requiring engineering drawings, contractor field verification, shop drawings, and as-built drawings. Such replacement also tends to lead to less accurate information, and a number of steps including process for education, inspection, and quality control, with a multiple handling required for each piece with significant logistical concerns for each piece. As another problem, the measurements and dimension data of older bridges is often inaccurately reported or the records are difficult to find or maintain.

The time required for steel bridge rehabilitation, and particularly for rivet removal and replacement leads to a number of secondary problems. These include extended overhead and liability; increased worker exposure and risk of injury; increased exposure to commuters on the roadways being serviced; worker injuries and traffic congestion during the rehabilitation process In turn, traffic congestion leads to wasted fuel and wasted time; lower economic productivity and slow delivery of goods and services.

As an example of the time requirements, the Long Island Bridge in Quincy, Mass. includes 120,000 rivets to be removed with replace-in-kind steel repair. The owners' engineers' estimate for the steel repair portion of the work includes 1000 days of contractor work.

A number of sophisticated techniques for cutting metal have, of course, been developed since the days of a riveted construction. Several of these include the ability to cut steel at a relatively high rate of speed and in sophisticated patterns. Of these, the three most common are laser cutting, plasma arc cutting, and water jet. Laser cutting focuses the energy of an intense laser beam against a particular coordinate on a workpiece to be cut and then follows a pattern, usually, but not necessarily computer-directed, to make the cut. Such cutting tools have gained adoption in machine shops as their ease of use has increased and their relative cost has decreased.

Laser cutting devices are difficult to mobilize, however, and because of focusing and power transmission issues, can typically only cut to a depth of between about 1 and 1 1/4 inch. This results because the laser has to be positioned close to the surface to be cut. In order to go deeper, the cutting head must get closer and in such circumstances the cutting head simply will not fit into small holes of greater depth. In this regard, rivet holes are typically at least 1 1/8 inch deep and often deeper.

As another disadvantage, lasers are high-intensity light sources, exposure to which can cause physical injury to workers. In a machine shop environment where the typical laser device is gantry-mounted and more easily shielded, this raises little or no problem. These characteristics, however, make lasers disadvantageous for more unconventional projects in ambient surroundings such as a rivet removal on existing outdoor structures where a cutting tool must be in frequent motion and occasionally (or always) hand-held by an operator.

Plasma arc torches, which cut by establishing a high-temperature electric arc between the cutting head and a metal workpiece (which typically acts as the ground for the arc) offer a number of the same advantages as lasers in controlled circumstances. Their disadvantages in rehabilitation environments are nevertheless similar to those of the laser, but with an additional significant disadvantage for rivet repair in existing structures. Specifically, a plasma torch heats metals to extremely high temperatures that can unfavorably change the characteristics of the metal itself. This is, of course, unacceptable for bridge or similar structure rehabilitation.

Perhaps more troublesome, both plasma and laser cutters will almost always create lead paint fumes that are problematic for the immediate workforce and the environment in general. Lead is the most acute environmental issue in bridge rehabilitation with potential inhalation being the biggest problem. Accordingly, methods that create, rather than abate, lead exposure are disadvantageous under such circumstances.

FIGS. 1 through 6 illustrate some background aspects of metal construction and rivet removal. FIG. 1 is a photograph taken from an existing bridge and showing the intersection of three girders and two main splice plates, and including several additional plies adjacent the girders and the splice plates, and all held together by rivets. FIG. 1 illustrates the large number of rivets required to be replaced to either more firmly secure the plies to one another, or to replace one or more of the girders, or to replace one or more of the splice plates.

FIG. 2 is an enlarged photograph of a rivet head that has corroded and is ready for replacement.

FIG. 3 is a photograph of five plies of structural components held together by two rivets and in which the structure has been cut longitudinally to the rivet axis to illustrate the manner in which rivets hold the plies together and more particularly the manner in which the rivet may be present in a hole which is not cylindrical, but is rather uneven based on the positions of the respective plies at the point at which they intersect with the rivet. As noted elsewhere herein, the lack of a cylindrical opening for the rivet and the interaction of the rivet with the uneven plies makes rivet removal particularly difficult using conventional techniques.

FIG. 4 is a photograph of a rivet hole after a rivet has been removed by conventional techniques and illustrating the relatively uneven opening that results. This uneven opening must be finished in some fashion using additional tools and labor before the rivet can be replaced with an appropriate bolt or other fastener.

FIG. 5 is another view of several metal structural components joined by rivets and illustrating the remainder of a rivet in its hole after the head has been removed. In particular, FIG. 5 illustrates the type of damage that can be incurred on the face of the component using conventional rivet removal techniques.

FIG. 6 is another environmental photograph showing the intersection of five girders each of which is joined to the over all structure by a single splice plate. FIG. 6 illustrates the large number of rivets that require removal in order to remove the splice plate for repair or, more typically, replacement.

Accordingly, a need exists for tools and techniques that can remove rivets more quickly, more consistently (and thus more predictably), and while avoiding extra steps for lead (or other) abatement, and for related apparatus and techniques that can increase the speed and predictability of structural rehabilitation of structures such as bridges, including improved methods of fabricating replacement components.

### SUMMARY OF INVENTION

In one aspect, the invention is a method of replacing custom or semi-custom structural components in place in existing structures, particularly large metal structures such as bridges. In this aspect, the method comprises positioning an x-y-z targeting device on an in situ structural component on a structure, sequentially moving the targeting device to a sufficient plurality of positions on the structural component to define the structure while transmitting x-y-z data from each sequential position to the processor, designing a substantially similar structural component based upon the transmitted position data, and fabricating a replica of the structural component from the transmitted information.

In another aspect, the invention is a method of replacing riveted metal components in place on existing metal structures. In this aspect, the method comprises positioning a rivet removing tool at a rivet on an in situ structural component that is maintained in place by a plurality of rivets, encoding the position of the rivet removing tool at the rivet and transmitting the encoded position of the rivet to a processor, removing the rivet, sequentially moving the rivet removing tool to each of the rivets in the structural component that hold the structural component in place, sequentially encoding the position of the rivet removing tool at each rivet, transmitting the encoded position of each rivet to the processor, and removing each rivet with the tool when the tool is at the rivet, designing a replacement component based upon the encoded positions of the rivets, and fabricating the replacement component based on the transmitted rivet positions.

In another aspect, the invention is a method of removing a rivet bridging two (or more) structural components with the rivet's heads on respective first and second opposite faces of the joined components (including plies), the method comprising directing a water jet having a sufficient pressure (and preferably an abrasive) to cut the component metal at the perimeter of a rivet on the first face of the joined components, while vacuum-removing materials from the kerf in the first face that are displaced by the water jet to thereby prevent the displaced materials from being released into the ambient environment, cutting the component until the water jet penetrates entirely through the joined components, and thereafter vacuum removing displaced materials from the first and second faces of the joined components until the desired cut is complete to thereby prevent materials displaced from the kerf or from either face from being released into the ambient environment.

In another aspect, the invention is an apparatus for cutting structural components in situ without releasing displaced materials, including lead paint and other potentially hazardous materials, the apparatus comprising, a water jet cutting head on a first face of a metal structural component (including joined components) for cutting into and through the structural component with the high pressure water jet, a first vacuum head adjacent to the cutting head on the first face for removing materials from the first face that are displaced by the water jet produced by the cutting head, a shrouded catcher on the second (opposite) face of the structural component for absorbing the water jet and displaced materials after the water jet penetrates the structural component, and a second vacuum head adjacent the second face of the component and in shrouded fluid communication with the catcher for removing the absorbed water and displaced materials from the second face of the structural component while preventing the water jet or the displaced materials from being released into the ambient surroundings or environment.

In another aspect, the invention is a rivet removal tool comprising a water jet head having a nozzle, means for moving the nozzle in three dimensions to a desired targeted position, and means for pivoting the nozzle at the targeted position along a defined solid sphere so that pivoting movement of the nozzle compensates the dispersion of the water jet to thereby reduce or eliminate fluting from the resulting hole in a structural component when the rivet is cut free therefrom.

In another aspect, the invention is a method of producing a defined cut in a structural component, the method comprising moving the nozzle of a water jet cutting device in three dimensions to a desired targeted position on the structural component, and directing a flow of high-pressure water from the nozzle sufficient to cut the component while moving the nozzle in a path that falls on a defined solid sphere to complete a clean substantially cylindrical cut through the component.

In yet another embodiment, the invention comprises a system for replacing custom or semi-custom structural components in situ and on-site on large (metal) structures that should not or can not be fully disassembled. In this embodiment, the invention comprises an encoding (digital) coordinate measuring machine for identifying and recording positions to which the measuring machine is moved, means for positioning the coordinate measuring device on a component to be replaced on an existing structure, means for removing the component from the structure, a processor in signal communication with the coordinate measuring machine for receiving encoded position information from the measuring machine, and a computer numerical control cutting machine in signal communication with the processor for producing a replacement component based on information from the processor.

The foregoing and other objects and advantages of the invention and the manner in which the same are accomplished will become clearer based on the followed detailed description taken in conjunction with the accompanying drawings.

### BRIEF DESCRIPTION OF DRAWINGS

FIG. 1 is a photograph of a splice plate and girders on an existing structure.

FIG. 2 is an enlarged photograph of a corroded rivet head.

FIG. 3 is a photograph of a cross-sectionally cut set of five plies and two rivets.

FIG. 4 is a photograph of a rivet hole following conventional rivet removal.

FIG. 5 is a photograph of several joined metal pieces after a rivet head has been removed in conventional fashion.

FIG. 6 is a photograph of a portion of a bridge structure that includes five girders joined at a splice plate.

FIG. 7 is a side elevation view of one embodiment of the invention in place on a workpiece.

FIG. 8 is a perspective view of a portion of the embodiment of FIG. 7.

FIG. 9 is a perspective view of another portion of the embodiment of FIG. 7.

FIG. 10 is a partial perspective, partial cross-sectional view of one embodiment of the invention.

FIG. 11 is a perspective view of several embodiments of the invention in place on a metal structure.

FIG. 12 is a perspective view of another embodiment of the invention.

FIG. 13 is a perspective view of one embodiment of the invention on a splice plate.

FIG. 14 is a perspective view of a metal-cutting gantry and a paint and finishing booth used in conjunction with the present invention.

FIG. 15 is a schematic diagram of one embodiment of the invention.

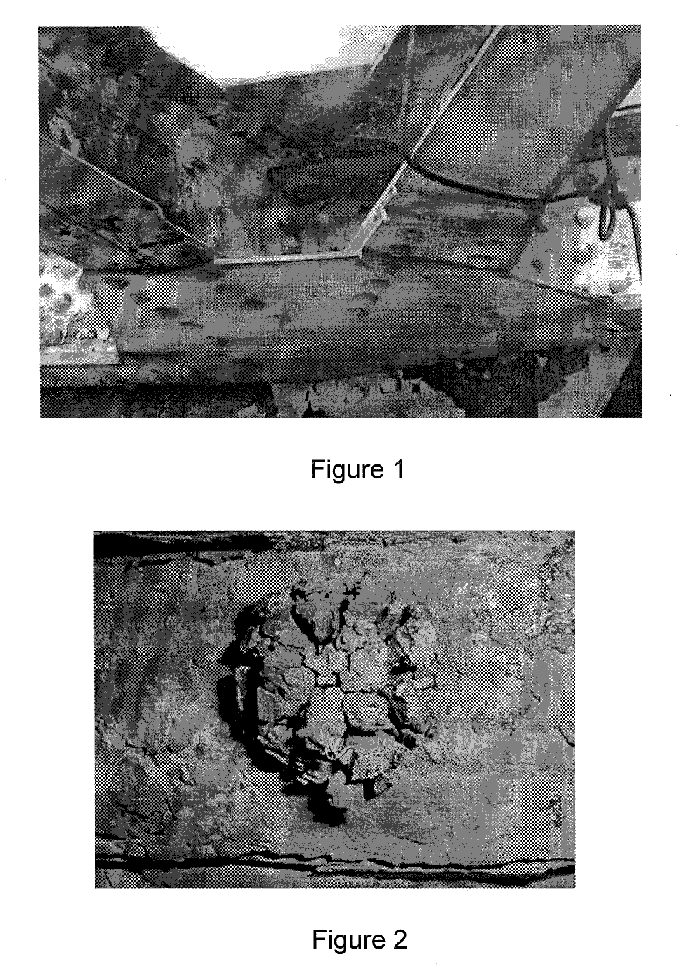

### DETAILED DESCRIPTION

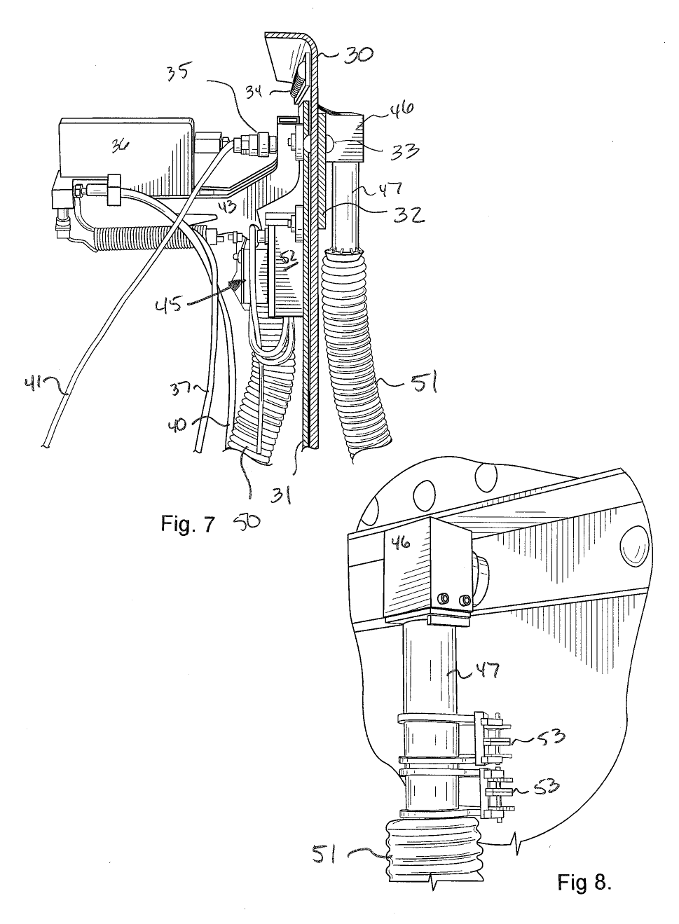

FIGS. 7 through 15 illustrate a number of aspects of the invention. In a first aspect, the invention is an apparatus for cutting structural components in-place without releasing displaced materials, including lead paint and other potentially hazardous materials. FIG. 7 illustrates such an apparatus in one aspect in which the structural component is illustrated as a first girder 30, a second girder 31, and a reinforcing ply 32. As illustrated in FIG. 7, a rivet 33 joins the first girder 30 to the ply 32. It will be understood, of course, that a number of other rivets typically join such pieces together, some of which are illustrated at 34 in FIG. 7.

The cutting apparatus includes a water jet cutting head 35 the nozzle of which is not visible in the view of FIG. 7. The water jet cutting head is positioned on a first face of the joined metal components 31, 30, and 32 for cutting into and through the components with the high-pressure water jet, which preferably carries an abrasive powder. The water jet can also potentially a surfactant (which reduces surface tension to produce smaller droplets that in turn increase the coherence and velocity of the water jet) and a rust inhibitor. Water jet cutting heads of the basic type described herein are generally well understood in the art, although usually used (as described in the background) in different circumstances. Some (although certainly not all) examples are set forth in U.S. Patents such as U.S. Pat. Nos. 6,315,640; 6,222,155; 5,637,030; 4,872,293; and 4,018,623. Other descriptions include Bandyopadhyay et al., “A Study on Use of Waterjet in Construction,” Technology Interface, Winter 1998. Water jet systems, including abrasives and ultra high pressure (“UHP”) pumps, are also commercially available, either from the assignees of one or more of the above patents or from other sources such as OMAX Corporation of Kent, Washington, USA.

The invention includes the pump housing 36 which is attached to respective tubes 37 and 40 which supply air and water to the pump head and to the water jet cutting head 35 along with (in preferred embodiments) an abrasive which is supplied to the cutting head 35 through the hose 41.

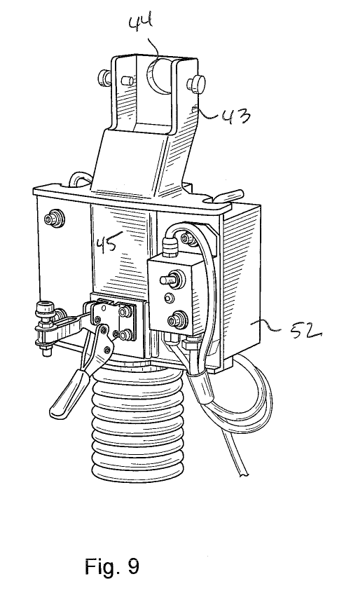

The drive and gear housing 36 and the cutting head 35 are mounted on a bracket 43 which in turn is aligned on a rivet by means of an opening 44 (FIG. 9). The bracket 43 thus serves as one method or means for aligning the cutting head 35 on a rivet on the structural components 30, 31 and 32. In FIG. 7, the bracket 43 obscures the position of the rivet being cut, but it is of course analogous to the position of the illustrated rivet 33.

The apparatus next includes a first vacuum head broadly designated at 45 that is adjacent the cutting head 35 on the first face of the structural component 31 for removing materials from the first face that are displaced by the water jet that is produced by the cutting head 35. As noted in the background portion of the specification, in addition to the metals that are being removed as a hole is being cut in the structural components, the vacuum head 45 advantageously removes any coating on the structural materials in the kerf path particularly including lead paint. Thus, the lead paint can be removed concurrently with the cutting of the hole, thereby eliminating one of the more labor-intensive steps in the conventional process, while in most circumstances eliminating the need for lead abatement.

FIGS. 7 and 8 illustrate that the apparatus further includes a shrouded catcher 46 on the second or opposite face of the joined structural components 30, 31 and 32 for absorbing the water jet, the abrasive, and displaced materials after the water jet penetrates the structural component. In this regard, it will be understood that the water jet operates at extremely high pressures, for example up to about 55,000 lbs. per square inch (psi). Accordingly, in preferred embodiments the shrouded catcher is formed of a material that has the required strength to absorb such force and in the more preferred embodiments is formed of an appropriately strong metal alloy such as boron carbide or an appropriate ceramic or ceramic composite.

A second vacuum head 47 is adjacent the second face of the joined components 30, 31 and 32 and is in shrouded fluid communication with the catcher 46 for removing the absorbed water and displaced material from the second face of the structural components while preventing the water jet or the displaced materials from being released into the ambient surroundings or environment. As part of the removal apparatus, the first vacuum head 45 is in communication with an appropriate vacuum hose 50, and the second vacuum head 47 in similar communication with a second vacuum hose 51. In preferred embodiments, the hoses 50 and 51 are in communication with a common vacuum pump for purposes of simplicity and inefficiency.

In order to make the apparatus convenient for use, it preferably includes magnets adjacent the cutting head and the shrouded catcher for mounting these elements to the structural components which, in rivet removal situations, are typically formed of metal. FIGS. 7 and 9 illustrate a first magnet 52 that maintains the bracket 43 and thus the cutting head 35 on the first face of the joined components and a magnet (or magnets) 53 on or adjacent the shrouded catcher 46 for mounting the catcher 46 to the opposite face of the structural components 30, 31 and 32. The magnets are illustrated as permanent magnets in FIGS. 7, 8 and 9, but can comprise electromagnets as may be desired or necessary.

FIG. 8 illustrates a number of the same elements as FIG. 7 but from a rear perspective rather than a side elevation view.

FIG. 9 illustrates that the drive and gear housing 36 and cutting head 35 are detachable from the first vacuum head 45 and that the rivet aligning means, illustrated in this embodiment as the hole 44 in the bracket 43, is fixed to the first vacuum head 45.

The apparatus illustrated in FIGS. 7, 8 and 9 thus facilitate a method of removing a rivet bridging two (or more) structural components with the rivet's heads on respective first and second opposite faces of the joined components (including plies). In this aspect, the invention comprises directing a water jet having a sufficient pressure to cut the component metal at the perimeter of the rivet on the first face of the joined components. The nature of the water jet is such that it can cut an opening of almost any size as may be desired, but typically will cut a circle, and thus a cylindrical hole, sufficient to remove the rivet, while avoiding removal of excess beneficial structural metal. In preferred embodiments, the component metal is cut around the entire perimeter of the rivet until the rivet is free of the component, after which the freed rivet is removed from the component.

In these method aspects of the invention, the water jet is directed at the component while concurrently vacuum removing materials from the kerf in the first face that are displaced by the water jet to thereby prevent the displaced materials from being released into the ambient environment, then cutting the component until the water jet penetrates entirely through the joined components, and thereafter vacuum removing displaced materials from the first and the second faces of the joined components until the desired cut is complete to thereby prevent materials displaced from the kerf or from either face from being released into the ambient environment.

As set forth with respect to the apparatus aspects, the method can include incorporating an abrasive (e.g. garnet) in the water jet to thereby increase, or otherwise differentiate the cutting capacity of the jet as compared to water alone. Additionally, the step of vacuum removing materials from the respective first and second faces comprises shrouding the first face and shrouding the second face to prevent the release of displaced materials or the highpressure water jet into the ambient environment.

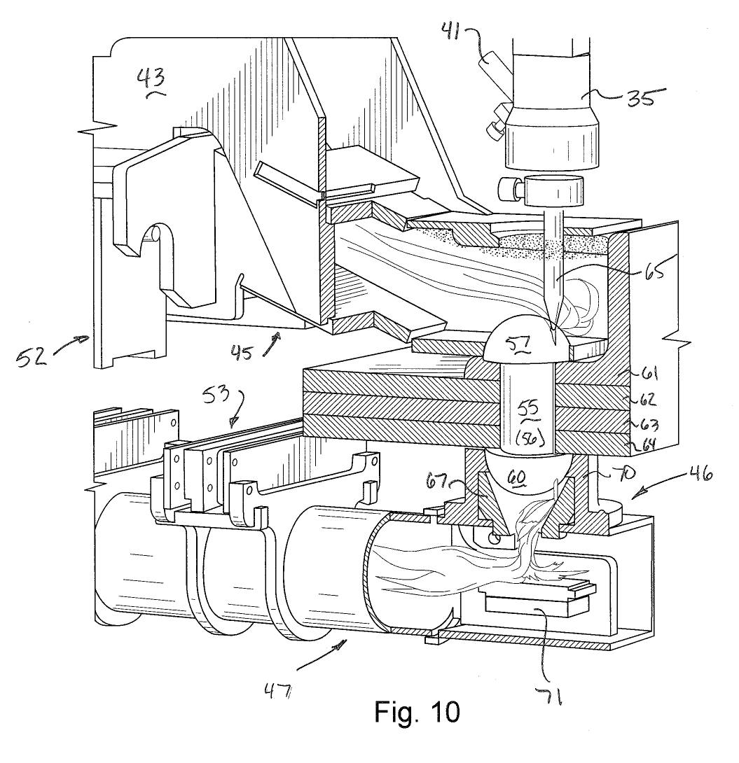

FIG. 10 is a partial perspective, partial cross-sectional view of a number of the elements illustrated in FIGS. 7, 8, and 9. Some of the elements are identical including the water jet cutting head 35, the hose supplying the abrasive 41, the bracket 43, the first magnet 52, the first vacuum head 45, the second set of magnets 43, the shrouded catcher 46, and the second vacuum head 47. A number of these elements are designated more broadly in FIG. 10 because of its larger scale and greater detail.

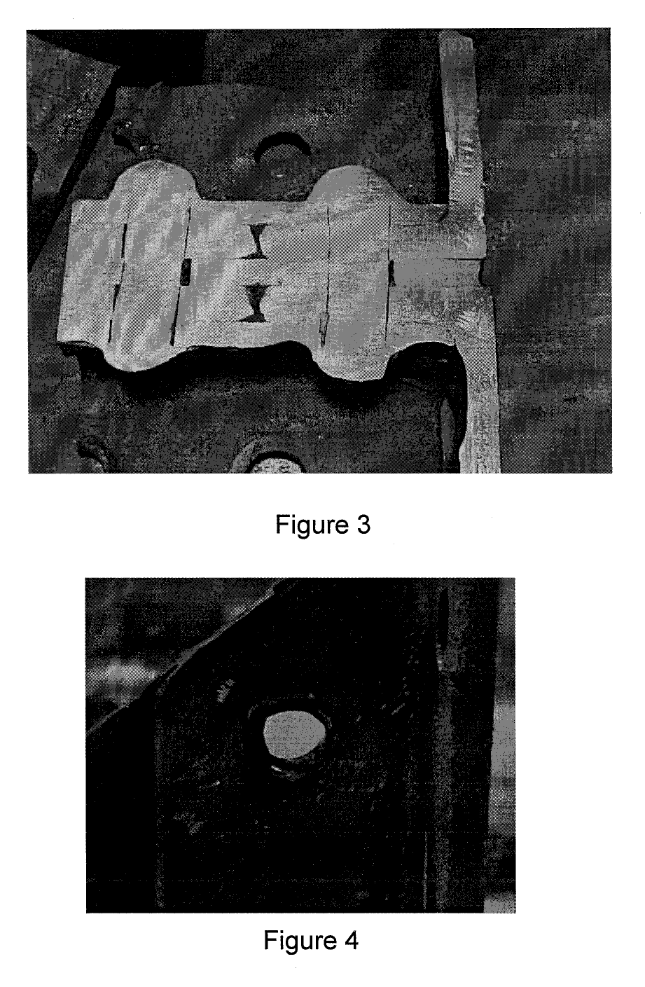

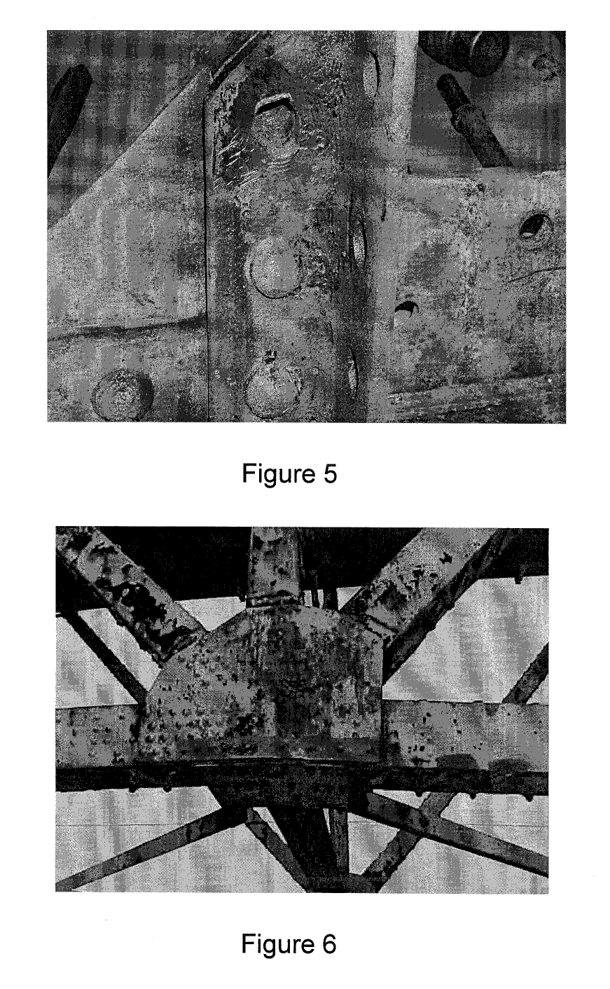

FIG. 10 illustrates a rivet 55 that has three characteristic portions: the shank 56 the first head 57, and the opposite head 60. The rivet 55 joins the layers of material respectively labeled as 61 through 64. As noted in the Background portion of the specification (e.g. FIG. 3), although FIG. 10 illustrates the rivet and the hole as being perfectly cylindrical, in actual practice the various layers 61, 62, 63, and 64 are typically slightly offset from one another. As a result, the shank 56 of a typical rivet 55 is not an ideal cylinder and instead interlocks with the offset plies in a manner that makes removing the rivet by conventional techniques relatively difficult.

FIG. 10 further illustrates the nozzle 65 that is shown slightly exploded from the water jet cutting head 35. It will be understood that this is for purposes of clarity in the illustration and that in actual practice the items are joined to one another with fittings suitable for high pressure. Portions of the nozzle 65, particularly its tip, are typically formed of sapphire in order to resist the erosive capability of the water jet (and potentially an abrasive) for a reasonable number of operating hours.

FIG. 10 also illustrates that the shrouded catcher 46 consists of a frustoconical portion 67 in an outer housing 70. The frustoconical portion 67 absorbs some of the initial energy of the water jet and displaced materials and directs them to a strike plate 71 at a lower position in the housing. The strike plate 61 also deflects the flow of materials in a manner that makes it easier to carry them off through the second vacuum head 47.

In preferred embodiments, the waterjet head 35 and the nozzle 65 include means for moving the nozzle 65 in three dimensions to a desired targeted position and means for pivoting the nozzle 65 at the targeted position along a defined solid sphere so that pivoting movement of the nozzle 65 compensates the dispersion of the water jet to thereby reduce or eliminate fluting from the resulting hole in the structural component.

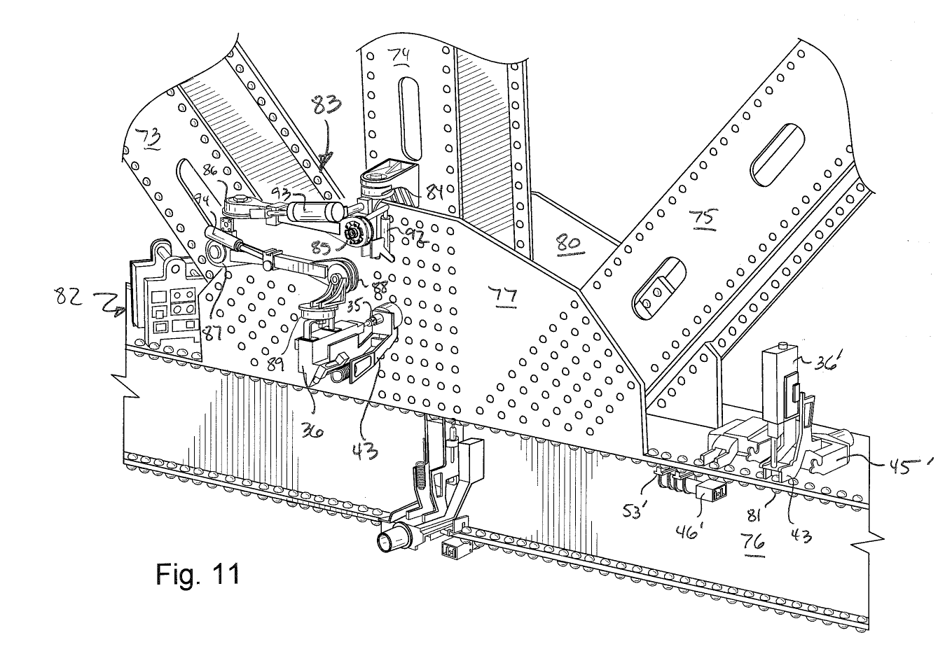

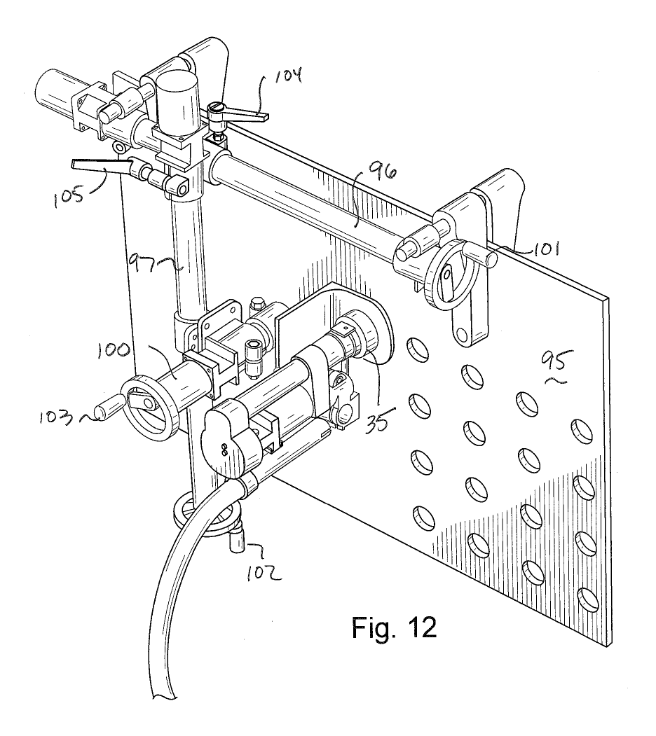

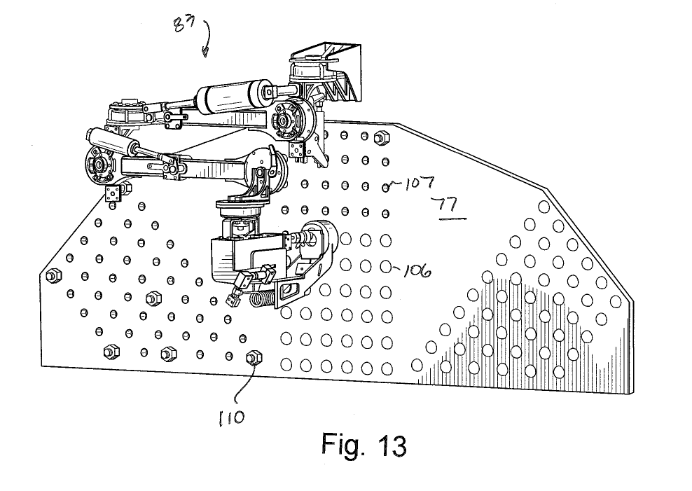

In preferred embodiments, the nozzle moving means is selected from the group consisting of multistage gantries (FIG. 12) and articulating arms (FIGS. 11 and 13). Functionally, the pivoting means offsets the nozzle 65 from a main axis (typically the main axis of the cutting head 35) and rotates the nozzle 65 about the main axis so that the nozzle 65 can be positioned in the main axis and rotated into any desired angle in a first plane normal to the main axis.

The movement of the nozzle in this manner can be accomplished by incorporating a number of well-known structures and techniques. These are typically referred to in the art in terms of multiple axes of movement, e.g. “5-axis” or “6-axis” tools. Of course, any position in real spacecan be defined in terms of three dimensions (typically expressed as x, y, and z). Thus the extra axes of movement referred to are often used to define the further rotational or sub-movement of a portion of a device (typically a tooling head) that has already been moved to a defined position. U.S. Pat. Nos. 6,622,575; 6,612,143; 6,590,212; 6,618,514; 4,101,405 and 3,559,529, although not directly related to rivet removal, are exemplary of the use of such terms to describe tool movements, and demonstrate that the required mechanical movements and structures are well-understood in this and other arts. Such movements and tools are also generally commercially well-understood; e.g. FIDIA S.p.A. of San Mauro Torinese, Italy and FIDIA Co. of Hoffman Estates, Ill. and Troy, Mich. (USA).

Because many, and sometimes all, of the rivets in a given structure will be the same size, in the more preferred embodiments the movement of the pivoting means is mechanically fixed based on the defined rivet size. Thus, although devices for moving the nozzle in multiple axes can be designed that have a wide range of motion, in the invention the design can limit the motion, and thus simplify the mechanical design and reduce the size to permit access to tight geometry positions while still providing the desired movement of the nozzle.

The purpose of the pivoting means is well understood by those familiar with the cutting arts, including laser cutting and plasma arc cutting. Specifically, in each of these techniques that cutting medium (the arc, the laser beam, or the water jet) will begin to disperse immediately upon exit from the source. Because the cut is made through a defined length or width of metal, this dispersion will result, if left unattended, in a hole that it is not perfectly cylindrical, but instead is wider in diameter at the bottom than at the top. This is referred to as “fluting” or “trumpeting” of the opening and in many cases is desirably avoided. The multiple axis movement capability of the nozzle compensates for the dispersion by tilting the nozzle slightly as it rotates so that the dispersion is directed either perpendicularly to the surface or inwardly towards the center axis of the eventual opening. In this manner, the apparatus can provide an almost perfectly cylindrical cut under a number of different conditions.

This mechanical capability also provides additional method aspects of the invention. These comprise moving the nozzle of the water jet cutting device in three dimensions to a desired targeted position on the structural component and then directing a flow of high pressure water from the nozzle sufficient to cut the component while moving the nozzle in a path that falls on a defined solid sphere to complete a clean, substantially cylindrical cut through the component.

In more detail, the method comprises moving the water jet nozzle to a rivet in the structural component, piercing the rivet with the water jet, and then making a circular cut in the component around the rivet while moving the nozzle in the path that falls on the defined solid sphere to thereby minimize or eliminate fluting in the resulting circular opening in the component. As in the other method aspects of the invention, the method can include shrouding the cut, vacuuming to remove the materials from both faces of the component, moving the nozzle on a plurality of gantry stages or an articulated arm or arms, and adding a flow of abrasive to the flow of high pressure water.

In a preferred embodiment, the nozzle is positioned at or near the center of the rivet to be removed. The water jet is then used to “pierce” the rivet; i.e. cut a jet-sized opening entirely through the rivet. The water jet is then directed in a “leading in” path from the center piece to the circumference of the rivet's shank. Finally, the water jet is then directed around the circumference of the shank to complete a circular cut and remove the rivet. In the more preferred embodiments, the piece and circular cuts incorporate a spherical (multi-axis) movement of the type described above, and the circular cut is preferably carried to about 367° or 368° in order to “clean up” the overall cut.

FIGS. 11, 12, 13, and 14 illustrate additional aspects of the method and apparatus of the invention. FIG. 11 is a perspective view of several embodiments of the invention in various positions on a bridge structure that includes four girders being joined together at two splice plates. For purposes of illustration, the girders are respectively numbered as 73, 74, 75, and 76 and the splice plates are designated at 77 and 80. A first apparatus according to the invention is positioned on the splice plate 77. It includes common elements previously described including the drive and gear housing 36, the cutting head 35 and the bracket 43. It will be understood that FIG. 11 can represent three different situations that can be carried out either separately or concurrently. Accordingly, FIG. 11 also illustrates a second drive and gear housing 36″ a second bracket 43″ on a rivet 81 along with the shrouded catcher 46″ the appropriate magnets 53″ and a vacuum head 45″. These elements are positioned on a horizontal portion of girder 76 and a third apparatus according to the invention is oriented vertically on the girder 76, and it will be understood that the elements are similar to those already described, but simply in a different orientation. FIG. 11 also illustrates an appropriate power source 82 that can include some controls for the apparatus.

In FIG. 11, the drive and gear housing 36 and the cutting head 35 are mounted or one or a system of articulating arms that are broadly designated at 83. The use of the articulating arms together with the water jet head 35 as the rivet removing tool provides a method of replacing custom or semi-custom structural components such as the splice plates 77 in place on existing structures such as the bridge portion indicated by the girders in FIG. 11. In this aspect, the method comprises positioning an X-Y-Z (i.e., three-dimensional) targeting device on a structural component in place on a structure. As used herein, the term “targeting device” refers to any device that can identify its position in three dimensions so that such position can be recorded or used in some other fashion. In the embodiment illustrated in FIG. 11, the articulating arm system 83 includes a plurality of pivot joints that are respect fully designated at 84, 85, 86, 87, 88, and 89.

Such articulating arms are generally well understood in a variety of arts and will not be described in further detail herein and are likewise generally commercially available. They operate in conjunction with one or more hydraulic (or air actuated or pneumatic) cylinders several of which are illustrated in FIG. 11 at 92, 93, and 94. Each of the pivot joints preferably contains a rotary movement sensor that has the capability to digitally encode its degree of relative movement. Additionally, the articulating arms can include linear position sensors. Accordingly, when the articulating arms system 83 is moved to a given position, it reaches such positions through the movement of one, several, or all of the pivot joints 84-89 and thus the sensors in such joints (and potentially arms) can identify the position of the cutting head 35 accurately in three dimensions.

Rotary position sensors are also generally well-understood in the art and commercially available from numerous sources, of which Positec Limited (Cheltenham, UK) and Novotechnik (Ostfildern, DE and Southborough, Mass., USA) are but two examples.

Stated more simply, once the articulating arms and 83 are fixed to the structure, the position of the cutting head 35 can be easily determined and digitally recorded.

Accordingly, in the next step in this aspect of the invention, the method comprises sequentially moving the targeting device, here the rivet removal tool, to a sufficient plurality of positions on the structural component (the splice plate 77 in FIG. 11) to define the structure while transmitting the x-y-z data from each sequential point to a processor. Once the data has been transmitted, the method comprises designing and a substantially similar structural component based upon the transmitted position data and fabricating a replica of the structural component from the transmitted information.

In the context of bridge rehabilitation, the method comprises positioning the rivet removal tool on a metal component of a metal structure and fabricating a metal replica of the structural component. The method is, of course, not limited to use on metal components. In a next logical step, the method comprises removing the defined structural components such as the splice plate 77 from the structure and replacing it with the replica component.

Where necessary to identify the specific shape of the component, the method can further comprise sequentially positioning the targeting device on a sufficient number of positions adjacent the perimeter of the component to substantially define the perimeter of the component and then designing the similar structural component with a substantially similar perimeter based upon the transmitted perimeter data. It will be understood that in some circumstances, the nature and position of the components such as the splice plate 77 is such that its entire perimeter must be carefully mapped and transmitted for replacement. In other circumstances, however, and FIG. 11 is illustrative of such a case, portions of the perimeter need not be identical in order to provide an appropriate replacement component. In such circumstances, the articulating arms system 83 and targeting device (or their functional equivalents) must be moved to and positioned at a sufficient portion of the perimeter to fabricate an appropriate replacement piece, but does not need to exactly trace the entire perimeter.

Because the invention can incorporate the rivet removing aspects of the invention as described earlier, the method preferably comprises replacing riveted metal components in place on existing metal structures. In this aspect, the method comprises positioning the rivet removing tool at a rivet on a structural component that is maintained in place by a plurality of rivets. The method comprises encoding the position of the rivet removing tool at the rivet and transmitting the encoded position of the rivet to a processor, removing the rivet, then sequentially moving the rivet removing tool to each of the rivets on the structural component that hold the structural component in place, sequentially encoding the position of the rivet removing tool at each rivet, transmitting the encoded position of each rivet to the processor, and removing each rivet with the tool when the tool is at the rivet. The method then comprises designing a replacement component based upon the encoded positions of the rivets (and potentially other information such as the perimeter) and then fabricating that replacement component based on the transmitted rivet positions.

In preferred embodiments, the articulating arms system 83 either is or functionally serves as a coordinate measuring machine that sends the required information to the processor and the step of fabricating the replacement comprises fabricating the replacement on a computer numerical control (“CNC”) machine. Coordinate measuring machines (“CMM”s') are likewise well understood in the art as exemplified by both recent (e.g. U.S. Pat. No. 6,622,114) and older (e.g. U.S. Pat. Nos. 3,393,459 and 3,386,174) patents. In recent years, CMMs have replaced more traditional measurement or inspection techniques (e.g. gauges) and are rated based on their measuring range and accuracy. CMMs are commercially available from numerous sources, of which Brown & Sharpe of North Kingstown, R.I. is one example.

In preferred embodiments, the computer numerical control machine is a gantry-based machine selected from the group consisting of plasma arc cutting machines and laser cutting machines. Because the replaced component is typically used in place on an outdoor structure, the step of fabricating the replacement component can comprise painting the replacement component, although those familiar with structural metal will recognize that some alloys will oxidize to a desired extent and form a protective coating without paint. The invention thus incorporates both aspects.

CNC machines are likewise well-understood in the art and commercially available. The “Alpharex” laser cutting system from ESAB (Florence, S.C.) is one (of potentially many) example as are U.S. Pat. Nos. 6,222,155 and 6,076,953.

FIG. 12 illustrates another aspect of the invention in which the cutting head 35 is positioned on a workpiece 95 using three separate hand-operated stages that are respectively designated at 96, 97, and 100. Each of the illustrated stages is hand-cranked using the respective handles 101, 102, and 103, but it will be understood that the stages could be mechanically advanced using servo drive electric motors and associated switches and controls. The respective stages can be clamped in place with clamps 104 and 105 being illustrated with respect to the stage 96. FIG. 12 thus illustrates that the method of the invention can be carried out with hand or operator use of the positioning system rather then an automated one such as illustrated in FIGS. 11 and 13.

FIG. 12 also illustrates that the step of positioning the rivet removal tool on a rivet can take advantage of the fact that many, even if not all, of the rivets on structural components being replaced will be positioned in regular or repetitive patterns; e.g. a fixed distance from center to center. Accordingly, once the centers of one or a few such rivets are identified by the targeting device, the positions of the remainder can be quickly and accurately calculated or predicted. Calculating the rivet's position, rather than simply observing it, becomes useful in those frequent cases in which the rivet head has become corroded, thus making the rivet's center difficult or impossible to locate visually. In turn, finding the rivet's center and removing it on that basis—provides the opportunity to minimize offcenter cuts and the resulting wasted efforts and larger holes that must be cut in order to remove the remainder of a rivet for which the position was misidentified.

In particular, when the positions of the initially-identified rivets are encoded in the manner discussed herein, the predicted or calculated positions of additional rivets can be provided to an operator in an appropriate output, for example a heads-up display. This allows the operator to move as quickly as possible from rivet to rivet while making the most accurate cuts for removal purposes.

FIG. 13 is another view of the articulating arm system 83 on the splice plate 77 and illustrating a plurality of rivets 106, a plurality of holes cut by the rivet removal tool 107, and a plurality of bolts 110 that are typically used to replace rivets in modern structural (bridge) rehabilitation. All of the other elements in FIG. 13 are identical to those illustrated in FIG. 11, and thus their descriptions will not be repeated herein in detail.

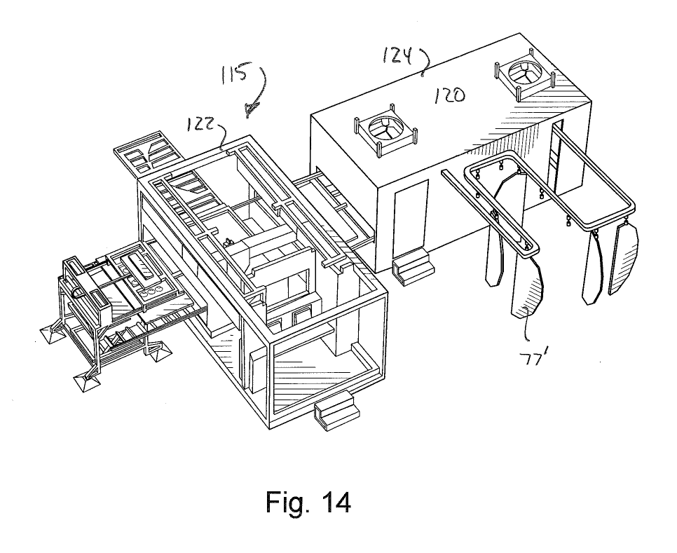

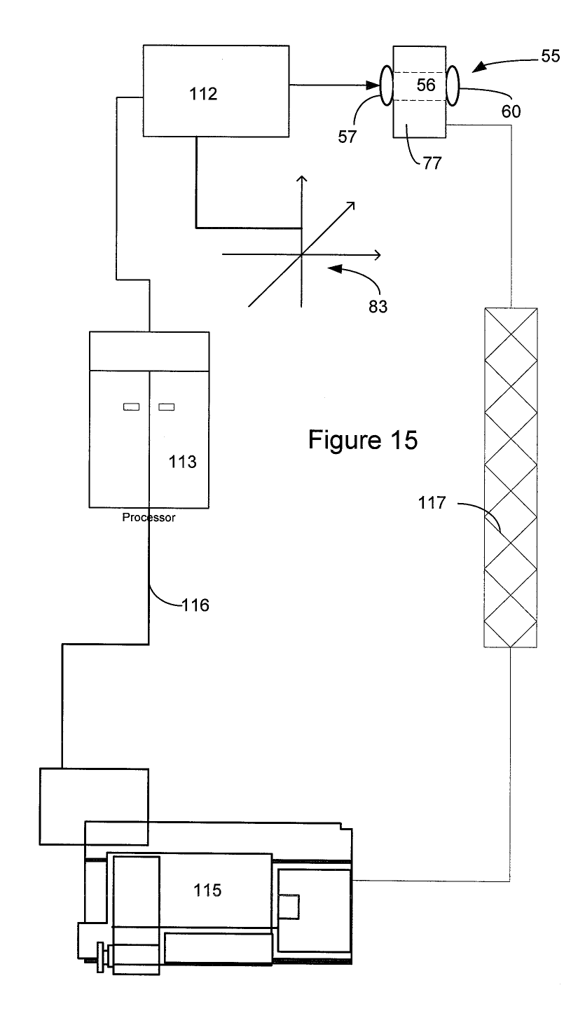

FIGS. 14 and 15 illustrate additional aspects of the intervention. In particular, FIGS. 14 and 15 illustrate that the invention also includes a system for replacing custom or semi-custom structural components in place and onsite on large metal structures, such as bridges, that should not or cannot be fully disassembled. In this embodiment, the invention comprises an encoding (preferably digital) coordinate measuring machine for identifying and recording positions to which the measuring device is moved, means for positioning the coordinate measuring device on a component to be replaced on an existing structure, means for removing the component from the structure, a processor in signal communication with the coordinate measuring machine for receiving encoded position information from the measuring machine, and a computer numerical controlled (“CNC”) cutting machine in signal communication with the processor for producing a replacement component based on information from the processor.

FIG. 14 is a perspective view of some, but not all of these elements, while FIG. 15 is a schematic view of the elements. FIGS. 14 and 15 incorporate similar reference numerals to the previous Figures wherever possible. It will be understood, of course, that FIG. 15 is schematic and thus not drawn to scale, but instead illustrates the invention in a manner that highlights its basic features, function, and operation. In FIG. 15, a workpiece is again designated at 77 to correspond to the splice plates illustrated in FIGS. 11 and 13. The rivet is broadly designated at 55 in a manner consistent with FIG. 10 and the rivet's components are again respectfully designated as 57 for the first head, 60 for the second head, and 56 for the shank. The articulating arm system illustrated in FIGS. 11 and 13 is shown schematically at 83 in FIG. 15 in the form of the x-y-z axis diagram. The coordinate measuring machine is designated at 112 and is in signal communication with a processor 113 through an appropriate signal channel 114. In many circumstances, the channel 114 will be an appropriate wire or cable, but given the rapid adoption of wireless standards for transmitting digital information between components over relatively short distances (e.g. 802.11b or “WiFi”), it will be understood that a physical connection between these elements is not required. The processor 113 can be any processor that is appropriate for the data being received and produced. As well known and understood by those of ordinary skill in this art, many of the software programs for computer numerical cutting machines and coordinate measuring machines are entirely compatible with conventional desktop or laptop personal computers and more sophisticated systems are not generally required unless some specific need exists for them. Accordingly, the nature of the processor and the software will not be discussed in detail herein given that these are widely and commercially available elements.

FIG. 15 illustrates a computer numerical controlled cutting machine at 115 which is likewise in signal communication with the processor through the cable 116 which, as noted with respect to cable 114, can be replaced by an appropriate wireless transmitter and receiver.

In accordance with the method aspects of the invention, the removal of the splice plate 77 and its replacement are carried out by removing the respective rivets, and thereafter using any appropriate mechanical lifting device which FIG. 15 schematically illustrates as the crane 117 to both remove the splice plate 77 from the existing structure and replace it with the new splice plate that is cut by the computer numerical controlled cutting machine 115.

In preferred embodiments, the component replacement system according to the invention further comprises finishing means for applying a protective coating to the replacement piece. FIG. 14 illustrates this as the paint booth and flash oven 120 which are positioned immediately adjacent to the computer numerical controlled cutting machine which is again designated at 115. In operation, the processor 113 designs the replacement piece (splice plate 77″ in FIG. 14) based on the encoded information from the measuring machine 112 and sends the design of the replacement piece to the computer numerical controlled cutting machine 115 to thereby produce a substantially identical replica of the removed piece.

In preferred embodiments, the computer numerical controlled cutting machine 115 and the paint booth and flash oven 120 are housed in respective containers 122 and 124 that are of the size and shape that are consistent with those used in the shipping and trucking industries. In this manner, these elements can be transported and moved into place on site at the structure being rehabilitated. Accordingly, with these elements in place the rivet removal tool can remove the rivets while concurrently mapping the shape of the replacement piece which can then be manufactured all on-site immediately and placed back into position and fixed in place in a matter of hours or even minutes as compared to days or weeks using conventional methods.

In the drawings and specification there has been set forth a preferred embodiment of the invention, and although specific terms have been employed, they are used in a generic and descriptive sense only and not for purposes of limitation, the scope of the invention being defined in the claims.

1. A method of replacing custom or semi-custom structural components in place on existing structures, the method comprising:
positioning an x-y-z targeting device on an in situ structural component on a structure;
sequentially moving the targeting device to a sufficient plurality of positions on the structural component to define the structure while transmitting x-y-z data from each sequential point to a processor;
designing a substantially similar structural component based upon the transmitted position data; and
fabricating a replica of the structural component from the transmitted information.

2. A replacement method according to claim 1 comprising positioning the targeting device on a metal component of a metal structure, and fabricating a metal replica of the structural component.

3. A replacement method according to claim 1 further comprising the steps of removing the defined structural component from the structure and replacing it with the replica component.

4. A replacement method according to claim 3 comprising:
positioning the targeting device on a riveted metal component of a metal structure;
sequentially moving the targeting device to a sufficient plurality of rivets on the structural component to define the structure while transmitting x-y-z data from each sequential rivet to the processor; and
removing the component from the structure by sequentially removing the rivets as the targeting device is moved thereto.

5. A replacement method according to claim 1 and further comprising sequentially positioning the targeting device at a sufficient number of positions adjacent the perimeter of the component to define the perimeter of the component; and
designing the similar structural component with a defined perimeter based upon the transmitted perimeter data.

6. A replacement method according to claim 4 wherein the step of positioning the targeting device on the metal component comprises positioning the targeting device on a splice plate that joins two or more girders.

7. A replacement method according to claim 4 comprising removing rivets that join at least three plies.

8. A replacement method according to claim 1 wherein the step of positioning the targeting device comprises positioning the targeting device with a gantry.

9. A replacement method according to claim 1 wherein the step of positioning the targeting device comprises positioning the targeting device with an articulating arm.

10. A method of replacing riveted metal components in place on existing metal structures, the method comprising:
positioning a rivet removing tool at a rivet on an in situ structural component that is maintained in place by a plurality of rivets;
encoding the position of the rivet removing tool at the rivet and transmitting the encoded position of the rivet to a processor;
removing the rivet;
sequentially moving the rivet removing tool to each of the rivets on the structural component that hold the structural component in place;
sequentially encoding the position of the rivet removing tool at each rivet, transmitting the encoded position of each rivet to the processor, and removing each rivet with the tool when the tool is at the rivet;
designing a replacement component based upon the encoded positions of the rivets; and
fabricating the replacement component based on the transmitted rivet positions.

11. A replacement method according to claim 10 further comprising the steps of removing the structural component and replacing it with the replacement component.

12. A replacement method according to claim 10 further comprising positioning the rivet removing tool at a plurality of positions on the perimeter of the component to define the perimeter shape of the component;
encoding the position of the rivet removing tool at the respective perimeter positions and transmitting the encoded the positions to the processor; and
designing and fabricating the replacement component with substantially the same perimeter as the original component.

13. A replacement method according to claim 10 comprising removing the rivet using a high-pressure water jet cutting system.

14. A replacement method according to claim 13 comprising including an abrasive in the water jet.

15. A replacement method according to claim 13 comprising including a surfactant in the water jet.

16. A replacement method according to claim 13 comprising including a rust inhibitor in the water jet.

17. A replacement method according to claim 10 wherein the steps of positioning the tool and encoding the position comprise positioning the tool with a coordinate measuring machine.

18. A replacement method according to claim 10 wherein the step of fabricating the replacement comprises fabricating the replacement on a computer numerical control machine.

19. A replacement method according to claim 18 comprising fabricating the replacement on a gantry-based computer numerical control machine selected from the group consisting of plasma arc cutting machines, laser cutting machines, drilling machines, water jet machines, and combinations thereof.

20. A replacement method according to claim 10 wherein the step of fabricating the replacement component comprises painting the replacement component.

21. A method of removing a rivet bridging two structural components with the rivet's heads on respective first and second opposite faces of the joined components, the method comprising:
directing a water jet having a sufficient pressure to cut the component metal at the perimeter of a rivet on the first face of the joined components;
while vacuum-removing materials from the kerf in the first face that are displaced by the water jet to thereby prevent the displaced materials from being released into the ambient environment;
cutting the component until the water jet penetrates the joined components; and
thereafter vacuum-removing displaced materials from the first and second faces of the joined components until the desired cut is complete to thereby prevent materials displaced from the kerf or from either face from being released into the ambient environment.

22. A rivet removal method according to claim 21 wherein the step of cutting the metal component comprises cutting the component around the shank of the rivet until the rivet is free of the component

23. A rivet removal method according to claim 22 comprising removing the freed rivet from the component.

24. A rivet removal method according to claim 21 comprising including an abrasive in the water jet to thereby increase the cutting capacity of the jet.

25. A rivet removal method according to claim 21 wherein the step of vacuum-removing materials from the first face comprises shrouding the first face.

26. A rivet removal method according to claim 21 wherein the step of vacuum-removing materials from the first and second faces comprises shrouding the second face.

27. An apparatus for cutting structural components in situ without releasing displaced materials, including lead paint and other potentially hazardous materials, said apparatus comprising:
a water jet cutting head on a first face of a metal structural component for cutting into and through the structural component with the water jet;
a first vacuum head adjacent said cutting head on the first face for removing materials from the first face that are displaced by water jet produced by said cutting head;
a shrouded catcher on the second face of the structural component for absorbing the water jet and displaced materials after the water jet penetrates the structural component;
a second vacuum head adjacent the second face of the component and in shrouded fluid communication with said catcher for removing the absorbed water and displaced material from the second face of the structural component while preventing the water jet or the displaced materials from being released into the ambient surroundings or environment.

28. A cutting apparatus according to claim 27 comprising:
a magnet on said cutting head for mounting said head to the structural component; and
a magnet on said shrouded catcher for mounting said catcher to the structural component.

29. A cutting apparatus according to claim 28 comprising respective electromagnets on said cutting head and on said shrouded catcher.

30. A cutting apparatus according to claim 28 comprising means for aligning said cutting head on a rivet on the structural component.

31. A cutting apparatus according to claim 27 comprising means for adding an abrasive to the water jet to increase the cutting capability of the water jet.

32. A cutting apparatus according to claim 30 wherein said cutting head is removable detachable from said first vacuum head and wherein said rivet aligning means is fixed to said first vacuum head.

33. A cutting apparatus according to claim 27 wherein said shrouded catcher is formed of boron carbide, a metal alloy, or a ceramic composite.

34. A cutting apparatus according to claim 27 comprising a common vacuum pump for both vacuum heads.

35. A rivet removal tool comprising:
a water jet head having a nozzle;
means for moving said nozzle in three dimensions to a desired targeted position; and
means for pivoting said nozzle at the targeted position along a defined solid sphere so that the pivoting movement of said nozzle compensates the dispersion of the water jet to thereby reduce or eliminate fluting from the resulting hole in a structural component when the rivet is cut free therefrom.

36. A rivet removal tool according to claim 35 comprising means for adding an abrasive to the water jet to increase the cutting capability of the water jet.

37. A rivet removal tool according to claim 35 wherein said nozzle moving means is selected from the group consisting of multi-stage gantries and articulating arms.

38. A rivet removal tool according to claim 35 wherein said pivoting means offsets said nozzle from a main axis and rotates said nozzle about the main axis so that said nozzle can be positioned in the main axis and rotated into any desired angle in a first plane normal to the main axis.

39. A rivet removal tool according to claim 35 wherein the movement of said pivoting means is mechanically fixed based on a defined rivet size.

40. A rivet removal tool according to claim 35 comprising means for aligning said nozzle on a rivet.

41. A method of producing a defined cut in a structural component, the method comprising:
moving the nozzle of a water jet cutting device in three dimensions to a desired targeted position on the structural component; and
directing a flow of high pressure water from the nozzle sufficient to cut the component while moving the nozzle in a path that falls on a defined solid sphere to complete a clean substantially cylindrical cut through the component.

42. A cutting method according to claim 41 comprising:
moving the water jet nozzle to a rivet in the structural component;
piercing the rivet with the water jet; and
making a circular cut in the component around the rivet while moving the nozzle in the path that falls on the defined solid sphere to thereby minimize or eliminate fluting in the resulting circular opening in the component.

43. A cutting method according to claim 42 comprising shrouding the targeted position on the component to prevent material being removed from the component from being released into the ambient environment.

44. A cutting method according to claim 42 comprising shrouding the side of the component opposite the targeted position to prevent material being removed from the component from being released into the ambient environment as the water jet cuts through the component.

45. A cutting method according to claim 43 comprising vacuuming the removed materials from the shrouded targeted position.

46. A cutting method according to claim 44 comprising vacuuming the removed materials from the shrouded opposite side of the component.

47. A cutting method according to claim 42 comprising moving the nozzle using a structure selected from the group consisting of multi-stage gantries and articulated arms.

48. A cutting method according to claim 42 comprising adding a flow of abrasive to the flow of high pressure water.

49. A system for replacing custom or semi-custom structural components in situ and on-site on large structures that should not or can not be fully disassembled, said system comprising:
an encoding coordinate measuring machine for identifying and recording positions to which said measuring device is moved;
means for positioning the coordinate measuring device on a component to be replaced on an existing structure;
means for removing the component from the structure;
a processor in signal communication with said coordinate measuring machine for receiving encoded position information from said measuring machine; and
a computer-numerical-controlled (CNC) cutting machine in signal communication with said processor for producing a replacement component based on information from said processor.

50. A component replacement system according to claim 49 further comprising finishing means for applying a protective coating to the replacement component.

51. A component replacement system according to claim 50 wherein said finishing means comprises a paint booth and a flash oven.

52. A component replacement system according to claim 49 wherein said coordinate measuring machine includes a support selected from the group consisting of multistage gantries and articulating arms.

53. A component replacement system according to claim 49 wherein said component removing means is a rivet removal tool.

54. A component replacement system according to claim 53 wherein said rivet removal tool is a high pressure water jet.

55. A component replacement system according to claim 49 comprising means for moving a replacement piece into place on the existing structure.

56. A component replacement system according to claim 55 comprising a crane.

57. A component replacement system according to claim 49 wherein said processor designs the replacement piece based on the encoded information from said measuring machine and sends the design of the replacement piece to the CNC cutting machine to thereby produce a substantially identical replica of the removed piece.
